(19) United States
(12) Patent Application Publication
(10) Pub. No.: US 2026/0098797 A1
(43) Pub. Date: Apr. 9, 2026

(54) METHOD AND SYSTEM FOR DETERMINING CORROSION OR A CORROSIVE ENVIRONMENT UNDER INSULATION

(71) Applicant: Senergetics B.V., Eindhoven (NL)

(72) Inventors: Frank Jacobs, Ospel (NL); Anitha, Veldhoven (NL)

(21) Appl. No.: 19/112,420

(22) PCT Filed: Oct. 11, 2023
(86) PCT No.: PCT/EP2023/078163

§ 371 Date: Mar. 17, 2025

(30) Foreign Application Priority Data
Oct. 17, 2022 (NL) 2033331

(51) Int. Cl. G01N 17/00; G01K 11/3206; G01L 1/24

(52) U.S. Cl. CPC G01N 17/00; G01K 11/3206; G01L 1/246

(57) ABSTRACT

A method for determining corrosion or a corrosive environment under insulation of an object where use is made of a corrosion determining assembly including multiple temperature sensors and a processor connected to the temperature sensors. The method includes measuring temperatures of an insulation layer and comparing the measured temperatures to expected temperatures. A corrosion determining assembly for determining corrosion or a corrosive environment under insulation of an object includes temperature sensors.

### CROSS-REFERENCE TO RELATED APPLICATIONS

This application is the National Stage of International Application No.

PCT/EP2023/078163, filed Oct. 11, 2023, which claims the benefit of Netherlands Application No. 2033331, filed Oct. 17, 2022, the contents of which is incorporated by reference herein.

### FIELD OF THE INVENTION

The invention is related to a method for determining corrosion under insulation of an object wherein use is made of a corrosion determining assembly. The invention is further related to a corrosion determining assembly for determining corrosion under insulation of an object.

### BACKGROUND OF THE INVENTION

A fluid, such as a gas, may be transported through a tubular pipe at a raised or lowered temperature relative to the environment. In order to maintain the temperature difference between the fluid and the environment, the tubular pipe is often insulated with an insulation layer which prevents thermal flow between the environment and the tubular pipe. However, even though the tubular pipe may be covered by an insulation layer the tubular pipe is still susceptible to corrosion. This is called corrosion under insulation. The insulation layer may comprise an inner insulation layer for insulating the pipe and an outer protection layer for protecting the inner insulation layer. For example, the outer protection layer may be a jacket, e.g. a metal or plastic jacket.

Corrosion under insulation may happen undetected until significant damage has occurred since the tubular is not visible. Thus corrosion under insulation presents a significant impediment for fluid transport and may greatly affect the performance of the tubular pipe. For example, hydrogen or heat, e.g. in the form of a heated fluid, may be transported in the tubular. In a more sustainable society, these fluid transports are expected to occur more frequently and closer to residential areas. It is important that corrosion under insulation is controlled or timely detected in these cases to allow for safe integration thereof.

Known methods to detect corrosion under insulation use destructive measures, such as removing the insulation layer to detect corrosion. These methods are both time consuming and expensive. US2020/0088663 A1 discloses a method for determining corrosion under insulation wherein temperature sensors are placed at an interface between a pipe and an insulation layer, i.e. underneath the insulation layer. The temperature sensors are then used to determine temperatures that promote a corrosion under insulation environment.

### SUMMARY OF THE INVENTION

The aim of the invention is to provide an improved method for determining the presence of a corrosive environment, e.g. corrosion, under insulation of an object. It is a further aim to provide a non-destructive method of determining a corrosive environment under insulation of an object.

The aim of the invention is achieved by the methods of the present disclosure.

The method for determining corrosion under insulation of an object, for example an elongated object, for example a tubular, covered by an insulation layer, makes use of a corrosion determining assembly comprising multiple temperature sensors and a processor. The object may be an elongated object such as a tubular for transporting a fluid, for example a heated fluid. However, the invention may work equally well for any object covered by an insulation layer. The object may have a same temperature as the environment or have a a temperature difference with the environment. The insulation layer may comprise a monolayer of insulating material or may comprise multiple layers, e.g. of insulating material and protective material. The object may be an elongated object such as a pipe. The object may further be used for storage, such as a storage tank, or a valve.

The corrosion determining assembly comprises multiple, for example more than 100, preferably more than 1000, temperature sensors and a processor connected to the temperature sensors. The temperature sensors may be embodied in various ways. In embodiments, the object is an elongated object and the temperature sensors are mounted to the elongated object distributed along a longitudinal axis thereof. The processor may be a processor assembly comprising one or more components, such as an interrogator, a computer system, a display system and/or computer storage.

The method comprises mounting the multiple temperature sensors on corresponding sensor locations on an outside of the outer protective layer of the insulation layer. The temperature sensors are mounted such that the insulation layer is between the temperature sensors and the object. Additionally, the temperature sensors are in thermal contact with the corresponding sensor location, such that the temperature sensors may measure the temperature of the corresponding sensor location.

The method of the invention is non-invasive because the temperature sensors are mounted on the outer protective layer of the insulation layer without removing the insulation layer. Furthermore, the method allows to mount the temperature sensors when the insulation layer and the object are already installed, e.g. the temperature sensors are not required to be provided on the object before the insulation layer is placed thereon.

The method further comprises measuring a temperature of each of the sensor locations of the insulation layer with the corresponding temperature sensor. The temperature sensors thus measure the temperature, e.g. on the outside, of the insulation layer on the sensor locations. The sensor locations may be specially marked locations. In embodiments, the sensor locations may be randomly chosen on the insulation layer or the sensor locations may be distributed over the insulation layer. The so-measured temperature of the sensor locations is then send to the processor, e.g. either wirelessly or through a wired connection between the temperature sensors and the processor.

The method comprises comparing each of the measured temperatures to corresponding expected temperatures for the respective sensor locations. For example, the expected temperatures may be an ambient temperature, possibly corrected with an offset to correct for heat generated by the object. For example, the expected temperatures may be based on a historical temperature data of the corresponding sensor location. For example, the expected temperatures may be based on a temperature of the object, possibly in combination with an insulation index of the insulation layer.

In embodiments, the corresponding expected temperatures may be related to previously measured temperatures at the respective locations. In embodiments, the corresponding expected temperature at a sensor location may be related to measured temperatures at other, e.g. adjacent, e.g. nearby, e.g. all other, sensor locations.

In embodiments, the expected temperature for comparing with the measured temperature at one of the sensor locations is related to measured temperatures at one or more of the other sensor locations. For example, the measured temperature at a sensor location may be compared to a measured temperature at an adjacent sensor location. For example, in embodiments wherein the temperature at the sensor locations is measured periodically or continuously, a change in the measured temperature may be compared to a change in measured temperature at another sensor location. For example, a measured temperature profile in time at a sensor location may be compared to a measured temperature location in time at another sensor location.

In embodiments, the temperature sensors may be classified, e.g. based on a location or a calibration temperature thereof. Each temperature sensor may be associated with a sensor group based on the classification. In embodiments, the sensors may be classified based on a measured temperature, e.g. a measured temperature curve, e.g. such that temperature sensors that measure similar temperatures are grouped together. The expected temperature for comparing with the measured temperatures of one of the sensors in a sensor group may be based on measured temperatures of sensors in the same sensor group. For example, in this embodiment, a corrosion or corrosive environment under insulation may be determined if a measured temperature of a sensor in a specific sensor group starts deviating from measured temperatures of other sensors in the same sensor group.

The method further comprises, determining by the processor, a corrosive environment under insulation, e.g. which is indicative of corrosion under insulation or a possibility of corrosion under insulation, of the object based on the comparison of the measured temperatures to corresponding expected temperatures. For example, if one of the measured temperatures deviates from the corresponding expected temperature for a normal functioning insulation layer. Or in another example, when the measured temperatures correspond to an expected temperature for corrosion under insulation. For example, the method may predict the occurrence of corrosion under insulation, e.g. before the corrosion is present, if one of the measured temperatures deviates or corresponds from the corresponding expected temperature. For example, the method allows to determine a location of the corrosion based on the sensor location where the deviation from the expected temperature is determined. For example, the processor may determine that the measured temperature deviates from the corresponding expected temperature when the expected temperature displays unexpected behavior relative to the expected temperature in a time domain. For example, the measured temperatures and the corresponding expected temperatures may be temperature profiles.

In embodiments, each of the temperature sensors may continuously or periodically monitor the temperature at the respective sensor locations. The measured temperature at each sensor location at a time may be compared to measured temperatures at the same time at other sensor locations, or with the measured temperatures at the same sensor locations at other times. If a relative change in temperature between the measured temperature and the expected temperature, e.g. based on the measured temperature at other locations and/or times, an analysis may be performed to determine a corrosive environment under insulation by the processor. For example, the processor may determine a corrosive environment under insulation by comparing the relative change in temperature to predetermined criteria, e.g. based on temperature change thresholds or temperature profiles.

The method may further comprise outputting a signal indicative of a presence of a corrosive environment and/or corrosion under insulation at a determined sensor location.

The invention is based on the insight that corrosion under insulation occurs as a result of moisture penetrating the insulation layer. Once the moisture reaches the object under the insulation layer, the object may start to corrode. The moisture in the insulation layer has the additional effect that a moist insulation layer generally has worse insulation properties, e.g. the insulation index of a moist insulation layer is lower or higher, e.g. worse, than the insulation index of a dry insulation layer. Thus a location where moist is present in the insulation layer may both have a temperature that deviates from an expected temperature of a dry location, and be a risk location for corrosion of the object covered by the insulation layer. By measuring for deviations in temperature these locations may be found and thus corrosion under insulation may be determined, e.g. detected or predicted. For example, this allows to determine corrosion under insulation even before the corrosion has started to form because the moisture will affect the insulation layer before the corrosion has started to form.

In embodiments, the corrosion determining assembly comprises an optical fiber having multiple fiber Bragg gratings with grating structures that comprise regions of alternating refractive index for measuring a temperature. Generally, an optical fiber with a fiber Bragg grating is an optical fiber having grating structures that that comprise of regions of alternating refractive index in the optical fiber. This may result in light, which is propagated through the optical fiber, to undergo a wavelength shift and be reflected by the fiber Bragg grating. The amount of wavelength shift of the light depends on the geometry of the fiber Bragg grating, which depends on the surrounding temperature through expansion and contraction of the optical fiber. Thus by measuring the wavelength shift, an expansion and/or contraction of the fiber may be determined which may be related to a temperature at the location of the fiber Bragg grating. The multiple fiber Bragg gratings form part of the multiple temperature sensors.

In this embodiment the corrosion determining assembly further comprises a light source for emitting light through the optical fiber and an optical sensor for measuring light emitted by the light source through the fiber Bragg grating. The light source may be a white light source, LED, a laser, or any other suitable light source. Both the light source and/or the optical sensor may be part of the processor, e.g. of an interrogator part of the processor.

The method in this embodiment comprises mounting the optical fiber on the insulation layer, for example parallel to a longitudinal axis of the object, such that the optical fiber at corresponding fiber Bragg gratings is in thermal contact with the corresponding sensor locations. The optical fiber may be mounted on the insulation layer by providing a thermal conductive material, e.g. such as a metal sheet, between the fiber and the outside of the insulation layer. The thermal conductive material may improve accuracy or efficiency of measuring the temperature with the optical fiber because of better thermal properties compared to other attaching methods.

Since corresponding fiber Bragg gratings of the optical fiber form part of the multiple temperature sensors, this method step forms part of the step mounting the multiple temperature sensors on corresponding sensor locations of the insulation layer such that the insulation layer is between the temperature sensors and the object and such that the temperature sensors are in thermal contact with the corresponding sensor locations. The corresponding sensor locations may be determined by the locations of the fiber Bragg gratings as the optical fiber is mounted onto the insulation layer. In embodiments, the optical fiber may have more fiber Bragg gratings than corresponding temperature sensors, such that one or more of the fiber Bragg gratings may be used for other purposes than measuring temperature, e.g. such as strain or humidity.

The method further comprises emitting light with the light source through the optical fiber and detecting the light with the optical sensor. The expansion or contraction of the optical fiber at each of the fiber Bragg gratings is then determined based on detecting a change in wavelength, e.g. a wavelength shift, of the emitted light with the optical sensor. For example, as the temperature increases, the fiber expands and the grating structure is expanded. This causes a shift in the wavelength compared to the expected shift if the temperature would have been constant. Thus the change in wavelength of the light detected by the optical sensor allows for determining the temperature. The processor then relates the determined expansion or contraction to a temperature of the insulation layer obtaining a measured temperature of each of the sensor locations.

This embodiment allows to determine corrosion under insulation by making use of the properties of the optical fiber having fiber Bragg gratings. This may result in (near) continuous temperature measurements of the insulation layer and allows local temperature measurements, e.g. on the outside of the insulation layer. This is an advantageous embodiment because the mounting of the optical fiber may be easier, some fiber Bragg gratings may be used for measuring other properties, such as strain or humidity, and/or it allows to easily measure a multitude of temperatures of the insulation layer.

(Near) continuous temperature measurements of the insulation layer is particularly advantageous when there are changing environmental conditions, e.g. such as a day/night cycle, or a wet/dry cycle. Continuous measuring allows to determine the changing conditions and allows to filter these environmental conditions and/or allows to use the environmental conditions as risk indicators, e.g. the expected temperatures may depend on the environmental conditions.

In embodiments, the emitting of the light through the optical fiber with the light source comprises emitting pulses of light and measuring a time between emitting the pulses and detecting the pulses with the optical sensor, and wherein the method further comprises relating the measured temperature to a corresponding sensor location based on the measured time. By measuring the time between emitting the pulse of light and detecting the pulse of light a travel time of the light through the optical fiber may be determined. This in turn may be related to a specific fiber Bragg grating which then allows to determine the sensor location on the insulation layer where a risk of corrosion under insulation is present. For example, a pulse may be emitted every few seconds, e.g. every 5 seconds or every 10 seconds, or a pulse may be emitted every minute, every 5 minutes, every half hour, every hour, depending on the use of the invention.

In embodiments, the fiber Bragg gratings have a corresponding, e.g. unique, grating structure in the optical fiber and wherein the method further comprises:
relating the detected change in wavelength to a corresponding sensor location based on the corresponding grating structure; and
relating the measured temperature to the corresponding sensor location.

The grating structures may cause a corresponding, e.g. unique, e.g. known, variation in the refractive index of the fiber Bragg grating as a result of having corresponding, e.g. unique, characteristics, e.g. geometries. The corresponding variations in the temperature then result in corresponding, e.g. known or unique, changes in the wavelength allowing to correspond a change in wavelength to a corresponding sensor location. For example, the corresponding grating structure may result in a reflection of a corresponding bandwidth of reflected light, depending on the contraction or extension of the optical fiber.

In embodiments, the measured temperature may be related to a corresponding sensor location using a combination of sending pulses and having grating structures that cause a corresponding wavelength band to be reflected.

In embodiments, the expected temperatures are an average of the measured temperatures. For example, every expected temperature may be the same and may be the average of the measured temperatures. For example, for every expected temperature, an average of previously measured corresponding temperatures may be determined and be taken to be the expected temperature. This allows to determine the expected temperatures for each sensor location separately. This is advantageous because the expected temperature may be influenced by outside factors, for example such as the presence of an outside heat source or environmental factors, such as presence of sun light or wind.

In embodiments, the expected temperatures for each sensor location are related to measured temperatures at other sensor locations. For example, comparing the measured temperature to the expected temperature at a sensor location may comprise comparing the measured temperature, e.g. a change in the measured temperature, to one or more measured temperatures at other sensor locations, e.g. a change in the one or more measured temperatures.

In embodiments, the method further comprises:
performing multiple measurements with the temperature sensors at different points in time, e.g. at regular time intervals, to obtain temperature data of each sensor location at the different points in time; and
storing the temperature data of each of the sensor locations.

In these embodiments, the method allows to determine a temperature profile the sensor locations through time. For example, it allows to determine and take into account periodic changes in the expected temperature, e.g. as a result of the day/night cycle. It further allows to determine a progress of the forming of corrosion under insulation when the temperature at a sensor location starts deviating from previously measured temperatures at the corresponding sensor location. This may allow to determine a more precise time when, a part of, the insulation layer has to be replaced or dried to prevent corrosion.

In further embodiments of the method, the expected temperature is an average of the temperature data of the corresponding sensor location.

In embodiments, the object is supported by multiple supports and wherein preferably the supports are in contact with the insulation layer at one or more of the sensor locations. For example, the object may be a tubular pipe supported by a frame work structure. For example, the object may be hanging from the supports, e.g. from a larger superstructure. The supports, in particular the connection of the supports to the insulation layer, may be the location of structural failure, e.g. due to corrosion. The method of the invention allows to determine the corrosion of the supports or a corrosive environment of the supports, e.g. the connection of the supports to the insulation layer or object, by determining a temperature and comparing the temperature to an expected temperature. Thus, the method may be used to improve safety of the support structure, e.g. by giving a warning when an increased chance of structural failure is present.

In further embodiments, the optical fiber is rigidly connected to one or more strain sensor locations at corresponding fiber Bragg gratings for measuring a strain thereon, wherein the method further comprises:
measuring a strain on strain sensor locations with the optical fiber by measuring an extension or contraction of the optical fiber at the corresponding fiber Bragg gratings and relating the expansion and contraction of the corresponding fiber Bragg gratings to the strain.

In this embodiment, some fiber Bragg gratings of the optical fiber may not be used for measuring a temperature but rather for measuring a strain. For example, movement of the supports may give an indication of a structural failure. By connecting the second optical fiber rigidly to the insulation layer, e.g. at or to the supports, the fiber will expand or contract when the object, e.g. the support, moves. This expansion and contraction allows to measure the strain on the fiber similarly to measuring the temperature, by sending a signal with an optical sensor and measuring a shift in wavelength. This allows to measure the strain on strain sensor location. For example, this embodiment of the method may comprise giving a warning on a possible structural failing of one of the supports based on the measured strain.

In embodiments, the sensor locations are located on an upper side and/or a lower side of the object. Moisture may be more likely to penetrate the insulation layer at an upper side, where moisture is more likely to come into contact with the insulation layer, or the lower side, where moisture is more likely to collect, of the object. By mounting the temperature sensors on the upper side and/or the lower side of the object, the method may be more likely to detect corrosion forming under the insulation layer.

In embodiments, the insulation layer comprises an inner insulating layer and an outer protective layer and preferably, wherein the multiple temperature sensors are mounted on the outer protective layer. For example, the outer protective layer may be a jacket, e.g. a metal jacket, to protect the inner insulation layer.

The invention is further related to a corrosion determining assembly for determining corrosion under insulation of an object, for example an elongated object, for example a tubular, covered by an insulation layer, wherein the corrosion determining assembly comprises multiple temperature sensors and a processor connected to the temperature sensors, wherein the assembly is configured to, when the multiple temperature sensors are mounted on corresponding sensor locations of the insulation layer such that the insulation layer is between the temperature sensors and the object, and such that the temperature sensors are in thermal contact with the corresponding sensor locations:
measure a temperature of each of the sensor locations of the insulation layer with the corresponding temperature sensor;
send the measured temperatures to the processor
compare, by the processor, each of the measured temperatures to corresponding expected temperatures; and
determine, by the processor, corrosion under insulation of the object based on the comparison of the measured temperatures to corresponding expected temperatures.

In embodiments, the assembly comprises an optical fiber having multiple fiber Bragg gratings with grating structures that comprise regions of alternating refractive index for measuring a temperature, a light source for propagating light through the optical fiber and an optical sensor for measuring light emitted by the light source, wherein corresponding fiber Bragg gratings of the optical fiber form part of the multiple temperature sensors and wherein the assembly is configured to, when the optical fiber is mounted on the insulation layer such that the fiber Bragg gratings are in contact with the corresponding sensor locations:
emit light through the optical fiber with the light source;
determine expansion or contraction of each of the fiber Bragg gratings by detecting a change in wavelength of the emitted light with the optical sensor; and
relate, by the processor, the expansion or contraction of the fiber Bragg gratings to a temperature of the insulation layer, obtaining a measured temperature of each of the sensor locations.

In further embodiments, the assembly is configured to, when emitting the light through the optical fiber with the light source, emit pulses of light and to measure a time between emitting the pulses and detecting the pulses with the optical sensor, and wherein the assembly is further configured to relate the measured temperature to a corresponding sensor location based on the measured time.

In further embodiments, the fiber Bragg gratings comprise corresponding, e.g. unique, grating structures in the optical fiber and wherein the assembly is further configured to:
relate the detected change in wavelength to a corresponding sensor location based on the corresponding grating structure; and
relate the measured temperature to the corresponding sensor location.

In embodiments of the assembly, the expected temperatures are an average of the measured temperatures.

In embodiments, the assembly is further configured to:
perform multiple measurements with the temperature sensors at different points in time, e.g. at regular time intervals, to obtain temperature data of each sensor location at the different points in time; and
store the temperature data of each of the sensor locations.

In embodiments of the assembly, the expected temperature is an average of the temperature data of the corresponding sensor location.

In embodiments of the assembly, the object is supported by multiple supports and wherein preferably the supports are in contact with the insulation layer at one or more of the sensor locations.

In embodiments of the assembly, the optical fiber is rigidly connectable to one or more strain sensor locations at corresponding fiber Bragg gratings for measuring a strain thereon, the assembly is further configured to:
measure a strain on the strain sensor locations, with the optical fiber by measuring an extension or contraction of the optical fiber at the corresponding fiber Bragg gratings and relating the expansion and contraction of the corresponding fiber Bragg gratings to the strain.

In embodiments of the assembly, the sensor locations are located on an upper side and/or a lower side of the outer protective layer.

In embodiments of the assembly, the insulation layer comprises an inner insulating layer and an outer protective layer and preferably, wherein the multiple temperature sensors are configured to be mounted on the outer protective layer.

A second aspect of the invention relates to a method for determining a performance of the insulation layer covering an object, for example an elongated object, for example a tubular pipe, wherein use is made of a insulation performance determining assembly comprising multiple temperature sensors and a processor connected to the temperature sensors, wherein the method comprises:
mounting the multiple temperature sensors on corresponding sensor locations of the insulation layer such that the insulation layer is between the temperature sensors and the object and such that the temperature sensors are in thermal contact with corresponding sensor locations;
measuring a temperature of each of the sensor locations of the insulation layer with the corresponding temperature sensor;
sending the measured temperature to the processor
comparing, by the processor, each of the measured temperatures to corresponding expected temperatures; and
determining, by the processor, a performance of the insulation based on the comparing of each of the measured temperatures to the corresponding expected temperatures.

The second aspect of the invention further relates to a insulation performance determining assembly for determining performance of an insulation layer covering an object, for example an elongated object, for example a tubular, wherein the insulation performance determining assembly comprises multiple temperature sensors and a processor connected to the temperature sensors,

wherein the assembly is configured to, when the multiple temperature sensors are mounted on corresponding sensor locations of the insulation layer such that the insulation layer is between the temperature sensors and the object, and such that the temperature sensors are in thermal contact with the corresponding sensor locations:
measure a temperature of each of the sensor locations of the insulation layer with the corresponding temperature sensor;
send the measured temperatures to the processor
compare, by the processor, each of the measured temperatures to corresponding expected temperatures; and
determine, by the processor, a performance of the insulation based on the comparing of each of the measured temperatures to the corresponding expected temperatures.

### BRIEF DESCRIPTION OF THE DRAWINGS

The invention will now be explained below with reference to the drawings in which:

FIG. 1a shows a cross section of an object covered by an insulation layer whereon temperature sensors are mounted;

FIG. 1b shows another cross section of an object covered by an insulation layer whereon temperature sensors are mounted;

FIG. 2 shows another cross section of a portion of an object covered by an insulation layer wherein an optical fiber having fiber Bragg gratings is mounted; and

FIG. 3 shows a corrosion determining assembly.

### DETAILED DESCRIPTION OF THE INVENTION

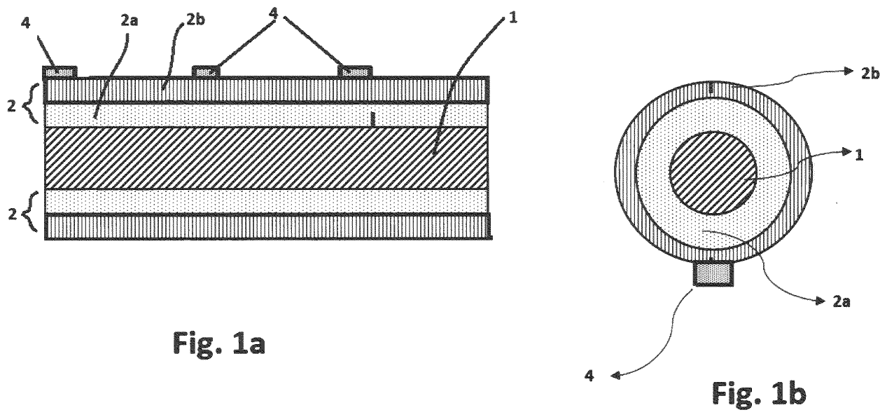

FIG. 1a shows a cross section of an object 1, in this case a tubular pipe 1, e.g. a portion of the object, covered by an insulation layer 2. The insulation layer 2 comprises an inner insulation layer 2a for insulation the object and an outer protection layer 2b for protecting the inner insulation layer. The outer protection layer 2b may be a protective layer 2b such as a jacket, e.g. a metal jacket.

Various temperature sensors 4 are mounted on the outer protection layer 2b of the insulation layer 2. The temperature sensors are mounted on the insulation layer 2 such that the insulation layer 2 is between the temperature sensors 4 and the object 1 and such that the temperature sensors 4 are in thermal contact with the insulation layer 2.

The temperature sensors 4 are mounted to the insulation layer 2 at sensor locations. In this figure, the temperature sensors 4 are mounted on a top side of the insulation layer 2. For example, the sensor locations may be the locations of the insulation layer 2 where the temperature sensors 4 are mounted. The sensor locations may be randomly chosen or they may be chosen based on indications on the insulation layer 2. In embodiments, the sensor locations are adjacent to supports of the object 1. The temperature sensors 4 are configured to measure a temperature of a corresponding sensor location of the insulation layer 2.

The temperature sensors 4 are connected to a processor 5, not shown in FIG. 1. The temperature sensors 4 may be connected via a wired connection or a wireless connection. The temperature sensors 4 are configured to send the measured temperatures to the processor 5.

The processor 5 is configured to
compare each of the measured temperatures to corresponding expected temperatures; and
determine corrosion under insulation of the object based on the comparison of the measured temperatures to corresponding expected temperatures.

The invention allows to non-invasively determine corrosion under insulation because the temperature sensors 4 may be mounted on the insulation layer 2 without removing the insulation layer. Furthermore, the invention allows to mount the temperature sensors 4 when the insulation layer 2 and the object 1 are already installed, e.g. the temperature sensors 4 are not required to be provided on the object 1 before the insulation layer 2 is placed thereon.

The invention is based on the insight that corrosion under insulation occurs as a result of moisture penetrating the insulation layer 2. Once the moisture reaches the object 1 under the insulation layer 2, the object may start to corrode. The moisture in the insulation layer 2 has the additional effect that a moist insulation layer 2 generally has worse insulation properties, e.g. the insulation index of a moist insulation layer 2 is lower than the insulation index of a dry insulation layer 2. Thus a sensor location where moist is present in the insulation layer 2 may both have a temperature that deviates from an expected temperature of a dry location, and be a risk location for corrosion of the object covered by the insulation layer. By measuring for deviations in temperature these locations may be found and thus corrosion under insulation may be determined, e.g. detected or predicted. For example, this allows to determine corrosion under insulation even before the corrosion has started to form because the moisture will affect the insulation layer 2 before the corrosion has started to form.

The expected temperatures used for comparing to corresponding measure temperatures may be an average of the measured temperatures. The expected temperatures, e.g. the average of the measured temperatures, may be corrected before comparing, for example they may be corrected for weather conditions.

The assembly may be configured to:
perform multiple measurements with the temperature sensors 4 at different points in time, e.g. at regular time intervals, to obtain temperature data of each sensor location at the different points in time; and
store the temperature data, for example with the processor 5, of each of the sensor locations.

This allows to form temperature profiles for each of the sensor locations. The temperature profiles may be used to compare to expected temperature profiles, and corrosion under insulation may be determined, e.g. predicted, based on comparing the measured temperature profiles to expected temperature profiles.

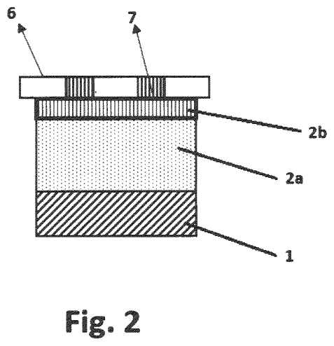

FIG. 2 shows another cross section of a portion of an object 1 covered by an insulation layer 2 having an inner insulation layer 2a and an outer protection layer 2b wherein an optical fiber 6 having fiber Bragg gratings 7 is mounted. In this figure, two fiber Bragg gratings 7 are shown, an optical fiber according to the invention may have a plurality, such as more than 100, preferably more than 1000, fiber Bragg gratings 7.

The optical fiber 6 has multiple fiber Bragg gratings 7 for measuring a temperature. The temperature causes variations in the reflected light of the optical fiber 6. The assembly further comprises a light source for emitting light through the optical fiber 6 and an optical sensor for measuring light emitted by the light source. The light sensor and the light source may be embodied as part of the processor 5, e.g. as part of in interrogator 5a which is part of the processor 5.

In this embodiment, corresponding fiber Bragg gratings 7 of the optical fiber 6 form part of the multiple temperature sensors 4. The optical fiber 6 is mounted on the insulation layer 2 such that the optical fiber 6 at the fiber Bragg gratings 7 is in thermal contact with the insulation layer 2. In embodiments, the optical fiber 6 may not be in thermal contact with the insulation layer 2 over the full length of the optical fiber 6.

The assembly is configured to:
emit light through the optical fiber 6 with the light source;
determine expansion or contraction of each of the fiber Bragg gratings 7 by detecting a change in wavelength of the emitted light with the optical sensor; and
relate, by the processor 5, the expansion or contraction of the fiber Bragg gratings to a temperature of the insulation layer, obtaining a measured temperature of each of the sensor locations.

This embodiment is an advantageous embodiment of the invention. For example, because some of the fiber Bragg gratings 7 may be configured to measure other properties than temperature, such as strain or humidity.

Light emitted through the optical fiber 6, may be emitted as pulses. By measuring the time between sending the pulse and the measuring of the reflection with the optical sensor, a location of the sensor location, e.g. along the optical fiber 6 or equivalently, when mounted, on the insulation layer, may be determined.

The determining of the location of the fiber Bragg gratings 7 may also be performed based on the wavelength or frequency of the measured light, when the fiber Bragg gratings 7 are configured to have a corresponding, e.g. unique, grating structure. In this embodiment, the processor 5 may be configured to:
relate the detected change in wavelength to a corresponding sensor location based on the corresponding grating structure; and
relate the measured temperature to the corresponding sensor location.

When the optical fiber 6 is rigidly connected to the insulation layer 6, e.g. at one or more supports of the object 1, corresponding fiber Bragg gratings may be used for measuring a strain on the optical fiber. Since the optical fiber 6 is rigidly connected at the fiber Bragg gratings 7, a movement of the object 1 causes an extension or contraction of the fiber 6, which may be measured with the fiber Bragg gratings 7. In this case, a strain on the object, e.g. on supports thereof, may be measured with the optical fiber 6 by measuring an extension or contraction of the optical fiber 6 at the corresponding fiber Bragg gratings 7 and relating the expansion and contraction of the corresponding fiber Bragg gratings 7 to the strain.

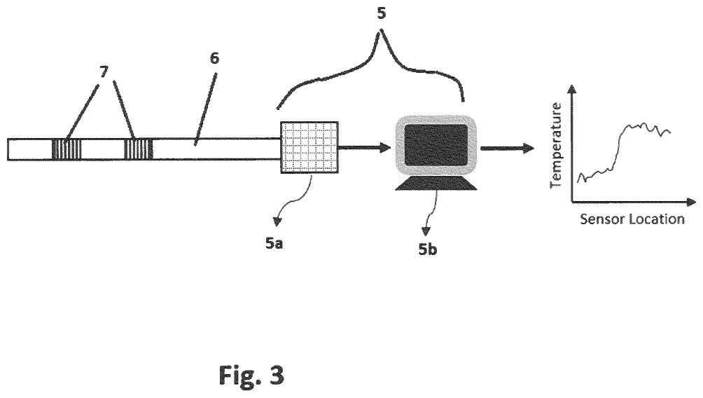

FIG. 3 shows a corrosion determining assembly having an optical fiber 6 with fiber Bragg gratings 7, and a processor 5 comprising an interrogator 5a, and a computer system 5b. A resulting temperature profile as measured by the assembly is shown as output of the computer system 5b.

1. A method for determining corrosion or a corrosive environment under insulation of an object, for example a tubular pipe, covered by an insulation layer comprising an inner insulation layer for insulating the object and an outer protective layer for protecting the inner insulation layer, wherein use is made of a corrosion determining assembly comprising multiple temperature sensors and a processor connected to the temperature sensors, wherein the method comprises:
mounting the multiple temperature sensors on corresponding sensor locations on an outside of the outer protective layer such that the insulation layer is between the temperature sensors and the object and such that the temperature sensors are in thermal contact with corresponding sensor locations which sensor locations are on the outside of the protective layer;
measuring a temperature of each of the sensor locations of the insulation layer with the corresponding temperature sensor;
sending the measured temperatures to the processor;
comparing, by the processor, each of the measured temperatures to corresponding expected temperatures; and
determining, by the processor, a corrosive environment under insulation or corrosion under insulation of the object at one or more of the sensor locations based on the comparison of the measured temperatures to corresponding expected temperatures.

2. The method according to claim 1, wherein the corrosion determining assembly comprises an optical fiber having multiple fiber Bragg gratings with grating structures that comprise regions of alternating refractive index for measuring a temperature, a light source for emitting light through the optical fiber and an optical sensor for measuring light propagated by the light source through the optical fiber, wherein corresponding fiber Bragg gratings form part of the multiple temperature sensors and wherein the method comprises:
mounting the optical fiber on the outer protective layer, for example parallel to a longitudinal axis of the object, such that the fiber Bragg gratings are in thermal contact with corresponding sensor locations;
emitting light through the optical fiber with the light source;
determining expansion or contraction of the optical fiber at each of the fiber Bragg gratings by detecting a change in wavelength of the emitted light with the optical sensor; and
relating, by the processor, the expansion or contraction of the fiber Bragg grating to a temperature of the insulation layer, obtaining a measured temperature of each of the sensor locations.

3. The method according to claim 2, wherein the emitting of the light through the optical fiber with the light source comprises emitting pulses of light and measuring a time between emitting the pulses and detecting the pulses with the optical sensor, and wherein the method further comprises relating the measured temperature to a corresponding sensor location based on the measured time.

4. The method according to claim 2, wherein each fiber Bragg grating comprise a corresponding, grating structure in the optical fiber and wherein the method further comprises:
relating the detected change in wavelength to a corresponding sensor location based on the corresponding grating structure; and
relating the measured temperature to the corresponding sensor location.

5. The method according to claim 1, wherein the expected temperature for comparing with the measured temperature at one of the sensor locations is related to measured temperatures at one or more of the other sensor locations.

6. The method according to claim 1, wherein the method further comprises:
performing multiple measurements with the temperature sensors at different points in time to obtain temperature data of each sensor location at the different points in time; and
storing the temperature data of each of the sensor locations.

7. The method according to claim 6, wherein the expected temperature is an average of the temperature data of the corresponding sensor location.

8. The method according to claim 1, wherein the object is supported by multiple supports and wherein preferably the supports are in contact with the insulation layer at one or more of the sensor locations.

9. The method according to claim 1, wherein the optical fiber is rigidly connected to one or more strain sensor locations at corresponding fiber Bragg gratings for measuring a strain thereon, wherein the method further comprises:
measuring a strain on strain sensor locations with the optical fiber by measuring an extension or contraction of the optical fiber at the corresponding fiber Bragg gratings and relating the expansion and contraction of the corresponding fiber Bragg gratings to the strain.

10. The method according to claim 1, wherein the sensor locations are located on an upper side and/or a lower side of the object.

11. (canceled)

12. A corrosion determining assembly for determining corrosion under insulation of an object, covered by an insulation layer comprising an inner insulation layer for insulating the object and an outer protective layer for protecting the inner insulation layer, wherein the corrosion determining assembly comprises multiple temperature sensors and a processor connected to the temperature sensors,
wherein the assembly is configured to, when the multiple temperature sensors are mounted on corresponding sensor locations on an outside of the outer protective layer such that the insulation layer is between the temperature sensors and the object, and such that the temperature sensors are in thermal contact with the corresponding sensor locations:
measure a temperature of each of the sensor locations with the corresponding temperature sensor;
send the measured temperatures to the processor;
compare, by the processor, each of the measured temperatures to corresponding expected temperatures; and
determine, by the processor, a corrosive environment under insulation or corrosion under insulation of the object based on the comparison of the measured temperatures to corresponding expected temperatures.

13. The assembly according to claim 12, comprising an optical fiber having multiple fiber Bragg gratings with grating structures that comprise regions of alternating refractive index for measuring a temperature, a light source for propagating light through the optical fiber and an optical sensor for measuring light emitted by the light source, wherein corresponding fiber Bragg gratings of the optical fiber form part of the multiple temperature sensors and wherein the assembly is configured to, when the optical fiber is mounted on the outer protective layer such that the fiber Bragg gratings are in contact with the corresponding sensor locations:
emit light through the optical fiber with the light source;
determine expansion or contraction of each of the fiber Bragg gratings by detecting a change in wavelength of the emitted light with the optical sensor; and
relate, by the processor, the expansion or contraction of the fiber Bragg gratings to a temperature of the insulation layer, obtaining a measured temperature of each of the sensor locations.

14. The assembly according to claim 13, wherein the assembly is configured to, when emitting the light through the optical fiber with the light source, emit pulses of light and to measure a time between emitting the pulses and detecting the pulses with the optical sensor, and wherein the assembly is further configured to relate the measured temperature to a corresponding sensor location based on the measured time.

15. The assembly according to claim 13, wherein the fiber Bragg gratings comprise corresponding, grating structures in the optical fiber and wherein the assembly is further configured to:
relate the detected change in wavelength to a corresponding sensor location based on the corresponding grating structure; and
relate the measured temperature to the corresponding sensor location.

16. The assembly according to claim 12, wherein the expected temperatures are an average of the measured temperatures.

17. The assembly according to claim 12, wherein the assembly is further configured to:
perform multiple measurements with the temperature sensors at different points in time to obtain temperature data of each sensor location at the different points in time; and
store the temperature data of each of the sensor locations.

18. The assembly according to claim 12, wherein the expected temperature is an average of the temperature data of the corresponding sensor location.

19. The assembly according to claim 12, wherein the object is supported by multiple supports and wherein preferably the supports are in contact with the insulation layer at one or more of the sensor locations.

20. The assembly according to claim 12, wherein, when the optical fiber is rigidly connected to one or more strain sensor locations at corresponding fiber Bragg gratings for measuring a strain thereon, the assembly is further configured to:
measure a strain on the strain sensor locations, with the optical fiber by measuring an extension or contraction of the optical fiber at the corresponding fiber Bragg gratings and relating the expansion and contraction of the corresponding fiber Bragg gratings to the strain.

21. The assembly according to claim 12, wherein the sensor locations are located on an upper side and/or a lower side of the object.

22. (canceled)
